(19) United States
(12) Patent Application Publication
(10) Pub. No.: US 2020/0156678 A1
(43) Pub. Date: May 21, 2020

(54) RAILROAD TRACK VERIFICATION AND SIGNAL TESTING SYSTEM

(71) Applicant: Herzog Technologies, Inc., St. Joseph, MO (US)

(72) Inventor: William K. Moss, Grenada, MS (US)

(73) Assignee: Herzog Technologies, Inc., St. Joseph, MO (US)

(21) Appl. No.: 16/689,654

(22) Filed: Nov. 20, 2019

Related U.S. Application Data
(60) Provisional application No. 62/769,896, filed on Nov. 20, 2018.

(51) Int. Cl. B61L 25/06; G06F 3/14; H04B 10/25

(52) U.S. Cl. CPC B61L 25/065; H04B 10/2504; G06F 3/14

(57) ABSTRACT

A track verification and signal testing system includes a central remote location comprising a computer system, the computer system hosting multiple workstations and monitors allowing test engineers to control inputs, and to monitor outputs, signals, and information associated with the verification and testing of a railroad track installation The computer system is in communication via a communications link with one or more automated field simulators, or control point field emulators (CPFE), placed in one or more signal bungalows housing the signal system circuitry associated with one or more sections of track.

### CROSS-REFERENCE TO RELATED APPLICATIONS

This application claims the benefit of U.S. Provisional Patent Application No. 62/769,896, filed Nov. 20, 2018, the disclosure of which is hereby incorporated herein in its entirety by reference.

### BACKGROUND

Railroads in the United States and elsewhere regularly install new track and track sections, and regularly upgrade and expand existing track installations. All such track installations must be verified to ensure that signals, lights, track circuits, and all associated wiring and communications circuitry is operating correctly prior to cutting-over the new track and making it available and open for use by actual railroad traffic.

Conventional systems and methods for verifying new track installations are time and labor intensive. Because each signal, light, track circuit, and other components and equipment comprising the track and signal circuity must be verified, known systems and methods for verification require the placement and use of multiple people at various points along the section of track or tracks to be verified, each with a communication device such as a walkie-talkie. Verification requires operating each sensor, switch, or device —such as a track switch—and confirming that a correct signal (or signals) is produced by operation of the switch. For example, by verifying a signal at a bungalow housing the track circuitry associated with the track, and further verifying, for example, that a signal light illuminates in response to the track switch and corresponding signal.

Such verification requires the near constant attention of each of the people involved in monitoring the various signals, switches, lights, etc., as well as coordination with a central control operator orchestrating the testing procedure and events.

Missed communications and communication interruption usually results in missed verification, and typically requires repeating or restarting the test sequence. Further complicating the operation is the necessity of sequentially activating various sensors and inputs, such as activating adjacent track switches intended to detect the presence of a train moving along the track sections under verification. Missed communications or inattentiveness of verification of resulting signals, lights, etc. during such a sequence of events can render the entire test sequence invalid and will often require repeating the entire test sequence. And, due to the expansive nature of railroad track installations, the multiple people involved and the various switches, signals, and lights involved are often not within line-of-sight of each other, further complicating the coordination of the test process.

Furthermore, in the case of verification of otherwise active track, the test operator must be in communication with railroad dispatch to ensure that the testing process does not interfere with continued operation of the rest of the track and the railroad system.

Conventional verification and testing thus requires multiple people to perform and typically consumes multiple days of testing for even relatively small track sections. Verification of larger track sections necessarily involves more people and requires more test time. The manpower and time required to complete verification testing results in high costs of cutting over and verifying track installations, as well as impacting the normal operation of the track involved.

Thus, it can be seen that there remains a need in the art for a track verification and signal testing system that reduces the number of personnel required to complete the verification and testing, reduces the time required to complete the verification and testing, and provides more reliable and verifiable results than with systems and methods known in the prior art.

### SUMMARY

Embodiments of the invention are defined by the claims below, not this summary. A high-level overview of various aspects of the invention is provided here to introduce a selection of concepts that are further described in the Detailed Description section below. This summary is not intended to identify key features or essential features of the claimed subject matter, nor is it intended to be used in isolation to determine the scope of the claimed subject matter. In brief, this disclosure describes, among other things, systems and methods for track verification and signal testing for railroad track installations.

In one embodiment, the track verification and signal testing system includes a central remote location comprising a computer system and/or server system, the computer system hosting multiple workstations and monitors allowing test engineers to control inputs, and to monitor outputs, signals, and information associated with the verification and testing of a railroad track installation The computer system is in communication via a communications link with one or more automated field simulators, or control point field emulators (CPFE), placed in one or more signal bungalows housing the signal system circuitry associated with one or more sections of track.

The CPFE is connected to the signal system circuitry, and includes its own circuitry for emulating various signal system inputs, and for monitoring various signal system outputs. With the CPFE connected to various inputs and outputs of the signal system circuitry in the bungalow, and in communication with the computer system of the remote central location, a test engineer at the remote central location can activate inputs to the signal system circuitry via commands issued on the central computer system and transmitted to the CPFE, and can likewise monitor outputs of the signal system circuitry via the CPFE.

Thus, once connected to the signal system circuitry in the bungalow, the CPFE can be remotely controlled from the remote central location to activate inputs and monitor outputs of the signal system circuitry without requiring personnel in the bungalow to activate inputs and monitor outputs.

The central remote location is preferably configured as a cutover trailer, a transportable trailer housing the computer system with multiple workstations and monitors, allowing test engineers to control inputs, and to monitor outputs, signals, and information associated with the verification and testing of a railroad track installation via the CPFE(s) installed in one or more bungalows.

The cutover trailer is transported to and positioned adjacent to, or in proximity to, a section or sections of track for verification and communicates to one or more CPFEs installed in one or more bungalows alongside the track housing the signal system control circuitry for corresponding sections of track. The computer system preferably communicates with the CPFEs via the fiber communications backbone of the railroad system.

In one aspect, the system of the present invention allows a small number of test engineers operating a human machine interface (HMI) of the computer system at the central remote location, or cutover trailer, to simulate signal system inputs and to monitor signal system outputs remotely, without necessitating multiple people positioned in the bungalows or in close proximity to the track itself.

In another aspect, the system provides a centralized location where all of the input and output signal information is aggregated for display to the test engineers for real-time monitoring of all current track and test conditions.

In another aspect, the system of the present invention allows iterative testing of multiple signal system input scenarios, and tracking and recording of corresponding outputs to verify test completion and results.

In yet another aspect, the system of the present invention allows training by allowing operators or inspectors to view the operation of various inputs and the resulting outputs in a controlled environment.

In another aspect, the system of the present invention allows a wayside interface unit (WIU) test tool (WTT) to be used in conjunction with the CPFE to simultaneously test a Positive Train Control (PTC) map file and configuration file installed on the WIU.

The track verification and signal testing system of the present invention allows one or two test engineers at a central location to quickly and efficiently verify and test signal system inputs and outputs of sections of tracks, to perform sequences of various test scenarios, and to aggregate the test and verification data at the central location, without reliance on multiple personnel located at multiple locations along the track sections being verified.

### DESCRIPTION OF THE DRAWINGS

Illustrative embodiments of the invention are described in detail below with reference to the attached drawing figures, and wherein:

FIG. 1 is a block diagram of a track verification and signal testing system in accordance with an exemplary embodiment of the present invention.

FIG. 2 is a depiction of a cutover trailer housing a central remote location computer system in accordance with an exemplary embodiment of the present invention.

FIG. 3 is depiction of the cutover trailer of FIG. 2 deployed in proximity to a railroad track installation.

FIG. 4 is a depiction of a workstation and central computer system setup located in the cutover trailer of FIG. 2.

FIG. 5 is a view of a plurality of monitors in communication with the central remote location computer system, each operable to display information about the track sections undergoing verification.

FIG. 6 is a depiction of a control point field emulator (CPFE) box of a system in accordance with an exemplary embodiment of the present invention.

FIG. 7 is a view of an exemplary bungalow used to house signal system circuitry in accordance with an exemplary embodiment of the present invention.

FIG. 8 is a view of the CPFE box of FIG. 6 in use in conjunction with the bungalow signal system circuitry of FIG. 7 in accordance with an exemplary embodiment of the present invention.

FIG. 9 is an alternative view of the CPFE box of FIG. 6 in use with the bungalow signal system circuitry of FIG. 7 in accordance with an exemplary embodiment of the present invention.

FIG. 10 is a screen shot of a display of information input to, and output from, a CPFE box in accordance with an exemplary embodiment of the present invention.

FIG. 11 is a screen shot of a display of information input to, and output from, a CPFE box in accordance with an exemplary embodiment of the present invention.

FIG. 12 is a screen shot of an office control monitor display of track sections under test in accordance with an exemplary embodiment of the present invention.

FIG. 13 is a depiction of a wayside interface unit test tool (WTT) that facilitates communication with a CPFE to provide positive train control (PTC) signal capability to the system of the present invention.

FIG. 14 is a graphical depiction of man-hour requirements for an exemplary track cutover and testing scenario using the system of the present invention.

FIG. 15 is a graphical depiction of man-hour requirements for an exemplary track cutover and testing scenario using conventional, known systems and techniques.

FIG. 16 is a graphical depiction of man-hour requirements for an exemplary pre-testing scenario using the system of the present invention.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The terms “about” or “approximately” as used herein denote deviations from the exact value in the form of changes or deviations that are insignificant to the function.

Embodiments of the invention include various configurations of a track verification and signal testing system. Various embodiments employ various techniques for providing input signals to signal system circuitry, for monitoring output signals from signal system circuitry, and for aggregating, storing, and displaying information and data relating to the track verification process.

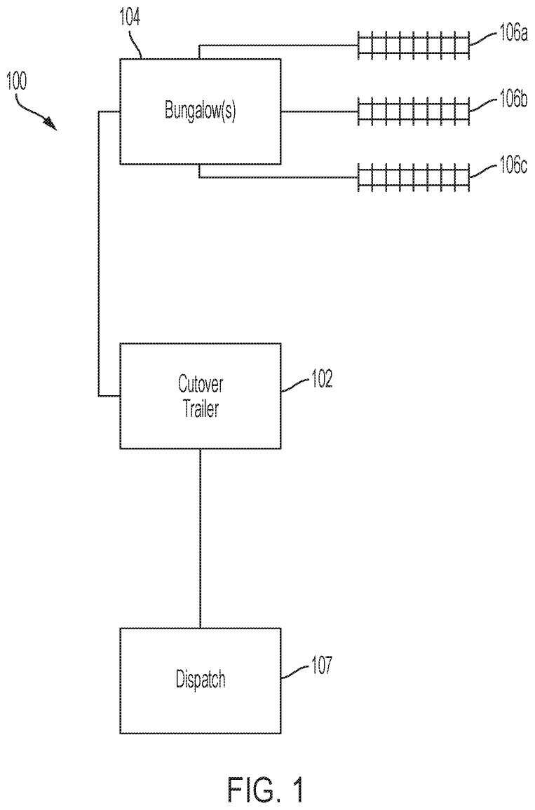

Looking first to FIG. 1, a block diagram of a track verification and signal testing system in accordance with an exemplary embodiment of the present invention is depicted generally by the numeral 100. The system generally comprises a cutover trailer 102, or central remote location, in communication with circuitry at one or more bungalows 104, the circuitry comprising signal system circuitry associated with one or more sections of railroad track 106a, 106b, 106c. As will be described in more detail hereinbelow, the cutover trailer 102 or central remote location provides a central computer system operable to communicate with one or more control point field emulators (CPFE) located at the one or more bungalows 104. Each CPFE includes circuitry operable to emulate inputs to the signal system circuitry at the bungalow, and circuitry operable to monitor outputs from the signal system circuitry.

Thus, a test engineer operating a workstation in communication with the central computer system can remotely activate inputs to the signal system circuitry by communicating with the CPFE to command the input, and can remotely monitor outputs of the signal system circuitry via display on one or more monitors of the work station or central computer system.

As also shown in FIG. 1, the cutover trailer 10s is preferably in communication with the existing railroad dispatch system so that test engineers can coordinate with dispatch to ensure the availability and clearance of track sections as may be required when track verification and signal system testing of track sections of operating railroad systems. Communication with the railroad dispatch ensures the safety of both the operating railroad system and the workers performing the test and verification operations.

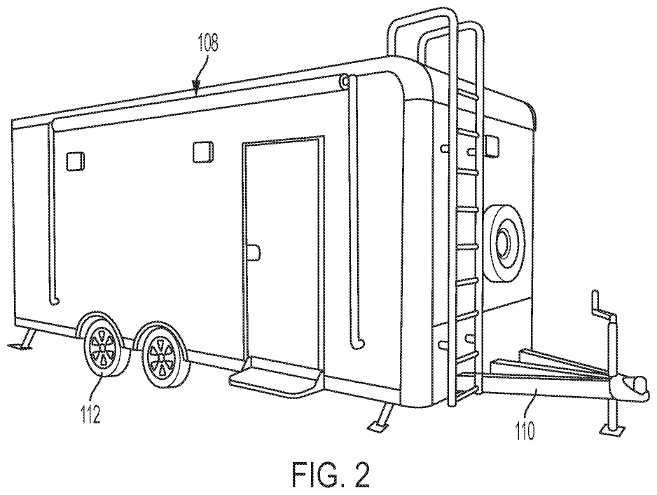

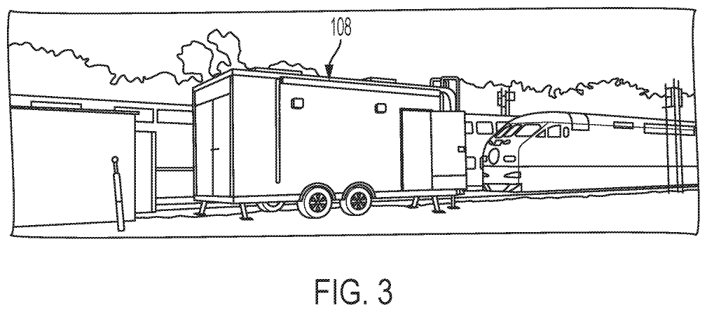

Looking to FIG. 2, a cutover trailer 108 is a transportable trailer unit having a hitch 110 and tires 112 allowing it to be towed via any transport vehicle to a desired location where the central remote location is to be set up. As shown in FIG. 3, typically the cutover trailer 108 will be located and positioned in general proximity to the railroad track sections that are to undergo verification and signal system testing. It should be understood that other configurations of the central remote location may be employed. For example, other sized trailers may be used, or the central computer system and associated work stations and monitors may be housed in other transportable vehicles, such as a bus, truck, or rail car. In other alternative embodiments, the central remote location may be housed in a transportable building structure or may be semi-permanently or permanently located in such a structure.

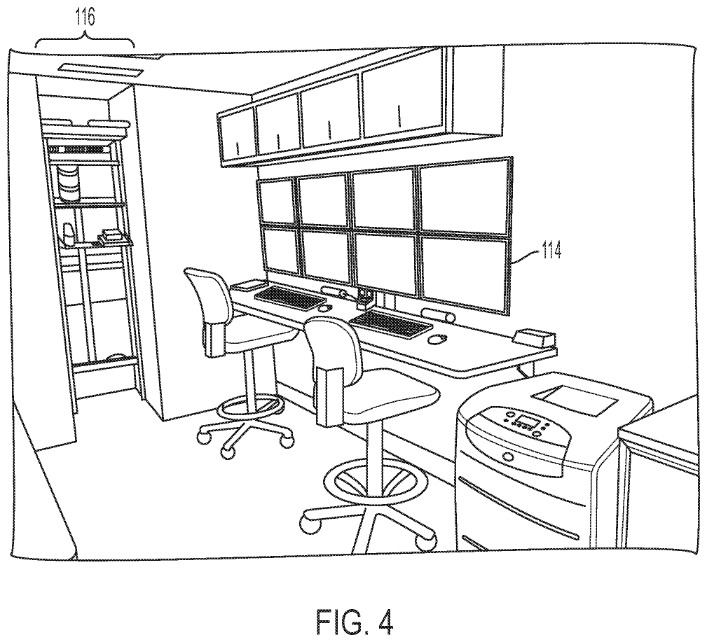

Looking to FIG. 4, a view of the interior of the cutover trailer of FIG. 2 shows a central computer and workstation setup 114 that provides one or more keyboards for input of commands by an operator and one or more monitors for displaying data and information associated with the track verification being performed. Test engineers, using the keyboards to provide input, can command various inputs to signal system circuitry by communicating with a CPFE located in the railroad bungalow housing the signal system circuitry associated with the track section undergoing verification. Communication from the central computer to the fiber backbone connecting the railroad bungalows is accomplished via interface circuitry 116 located in the cutover trailer and in communication with the central computer system.

In addition to direct control of inputs to the signal system circuitry, the central computer system allows test engineers to execute sequences of commands to simulate sequences of actual events, such as the successive activation of track switches on consecutive sections of track, simulating the progression of a train along those sections of track. Simultaneously, the test engineers are able to monitor the status of various signal system circuitry outputs, such as outputs to activate signal lights. Thus, a test engineer in the cutover trailer, or central remote location, can emulate various combinations and scenarios of inputs and monitor the corresponding outputs to ensure the proper and expected operation of the signal system circuitry.

Preferably, the central computer system records and logs the operations and tests instigated by the test engineer, and likewise records the occurring outputs. Thus, entire tests, sequences of tests, and groups of tests can be conducted, verified and recorded from the central remote location at the cutover trailer.

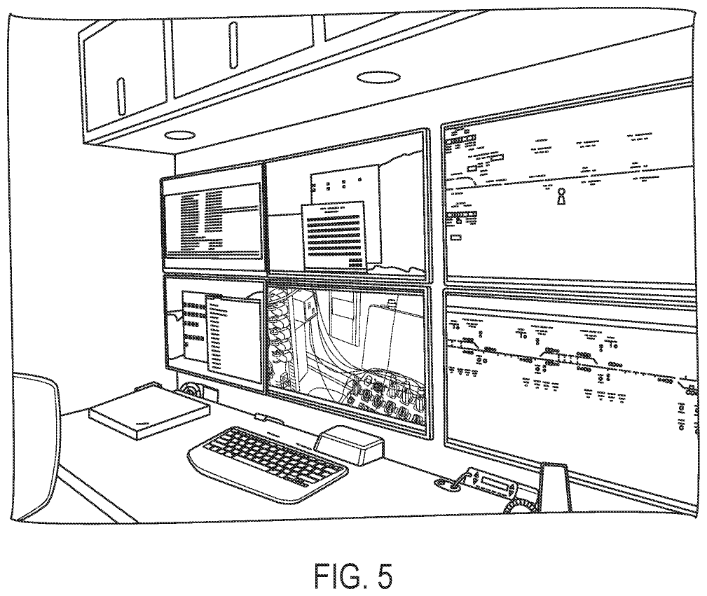

Looking to FIG. 5, a depiction of the system of the present invention in operation shows multiple monitors displaying various input and output parameters in conjunction with graphical depictions of the track sections associated with those various inputs and outputs.

As described above, bungalows located alongside sections of railroad track house signal system circuitry that monitors the status of various switches and sensors located on or along the track, and that provides outputs to various signals, lights, and other controls and indicators on or along the track. The bungalows provide a housing for the signal system circuitry, and an interface between that circuitry and the switches, sensors, lights, etc., a power supply to power the circuitry, and an interface to the railroad communication fiber backbone.

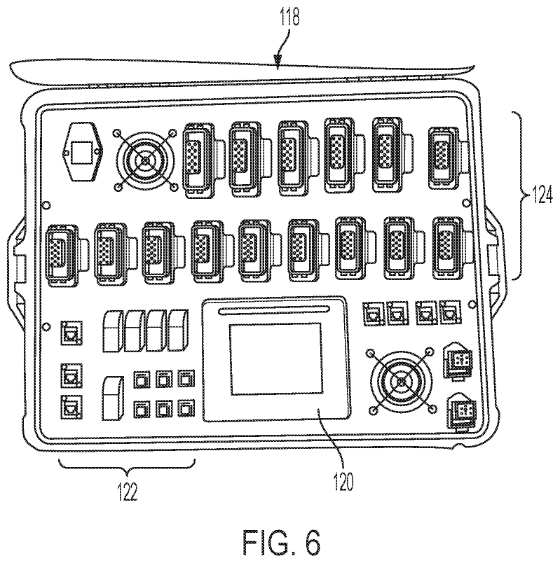

Turning now to FIG. 6, a control point field emulator (CPFE) box is depicted by the numeral 118. CPFE 118 comprises internal circuitry that allows emulating various switch and sensor inputs and outputs corresponding to switches and sensors physically present on the track and rail system. For example, a switch on a section of track that is used to detect the presence of a train on that track section is emulated by the CPFE so that a test engineer or operator can simulate the presence of a train on a track system by activating the corresponding switch emulator on the CPFE. The CPFE may likewise be used to emulate the operation of any switch or sensor associated with track section.

Thus, in the case of verifying the operation of a length of track, one or more CPFEs may be placed in the circuitry bungalows positioned at intervals alongside the track. Controlling the CPFE(s) from the remote central location—i.e., cutover trailer—the test engineers can emulate the operation of the switches and sensors which are fed into the railroad communications backbone such that the railroad system “sees” the emulated inputs from the CPFE(s) as actual inputs from the corresponding switches and sensors. The railroad system thus reacts to those switches and sensors as if a train was in operation on the track and the test engineers can monitor and record the actions of the railroad system to the emulated inputs to ensure that the railroad system responds correctly and is thus configured correctly. Any deviations to expected operation can be isolated and remedied before the section of track is opened to actual rail car traffic.

Similarly, the CPFE(s) allow monitoring of commands or outputs from the track and rail system to ensure and further verify operation of the system. For example, the CPFE may be interfaced (via circuity in a bungalow adjacent the track section) to light, sound, and other outputs generated by the track and rail system. Thus, for example, the CPFE(s) can monitor a signal light output to allow verification that the light is illuminated by the track and rail system at the appropriate time. Likewise, bell or alarm outputs, or any other commands, outputs, or indicators generated by the track and rail system can be monitored to ensure proper operation.

It can be seen that the CPFE(s), interfaced to the track and rail system circuitry thus allows emulation of any or all sensors and signals used by a section of track being verified to ensure correct operation of the track and rail system before opening the track to actual rail car traffic.

The CPFE 118 preferably provides a monitor screen 120 that provides information to an operator regarding the status of various inputs, outputs, and status of the CPFE. A plurality of switches 122 allow configuration of the CPFE box, and allow testing and simulation of inputs. A plurality of electrical connectors 124 provide an interface between the internal circuitry of the CPFE and the signal system circuitry in the bungalow, with wiring connected between the electrical connectors 124 and the appropriate wiring and/or connectors of the signal system circuitry for the corresponding input being emulated and/or the output being monitored.

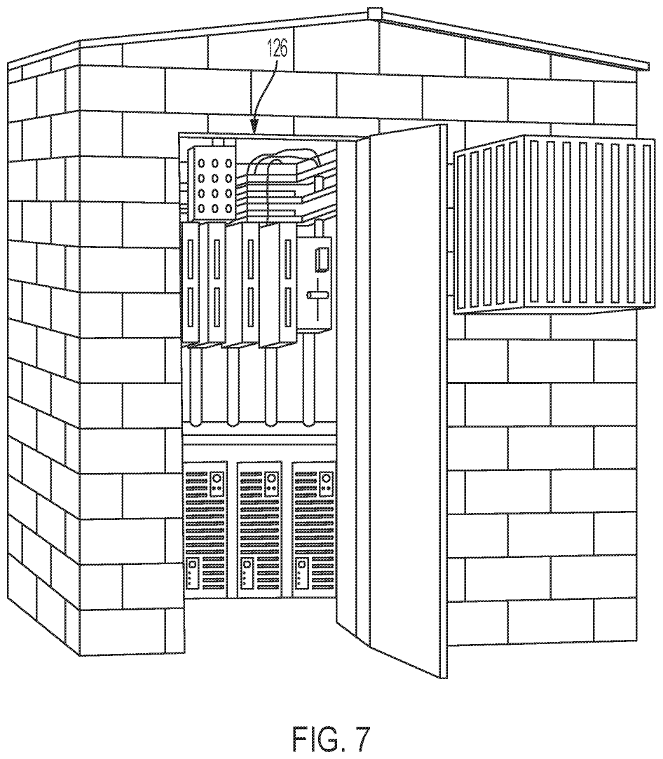

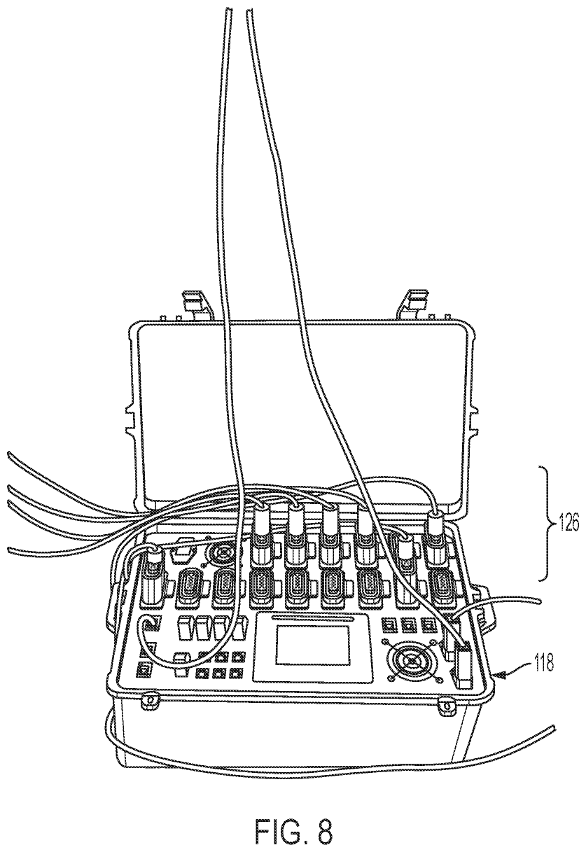

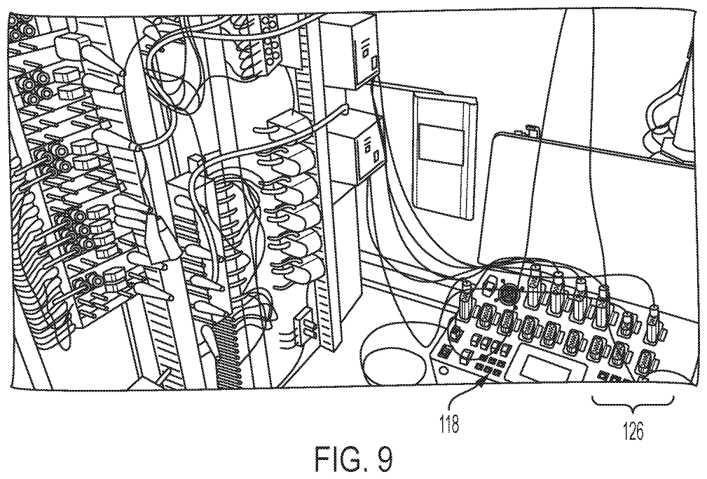

Looking to FIG. 7, a view of the interior of an exemplary bungalow test building shows a portion of the signal system circuitry contained therein. FIGS. 8 and 9 depict a CPFE 118 with wiring between the electrical connectors 124 and the signal system circuitry.

Most preferably, the CPFE circuitry includes at least the following features and capabilities: the ability to simulate four switch machines, the ability to simulate or monitor up to thirty lamps, eight DC track outputs, four ElectroCode track circuits, sixteen discrete outputs to control signal inputs, eight discrete inputs to monitor miscellaneous signal outputs, two remote link controls to remotely break and make vital links, and built-in Ethernet switch to allow additional components.

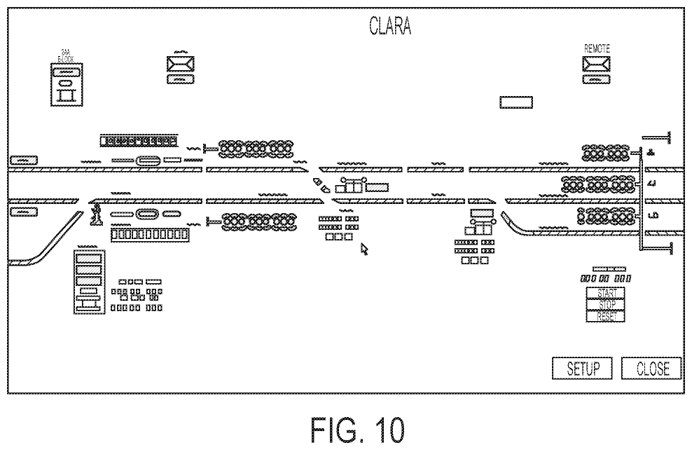

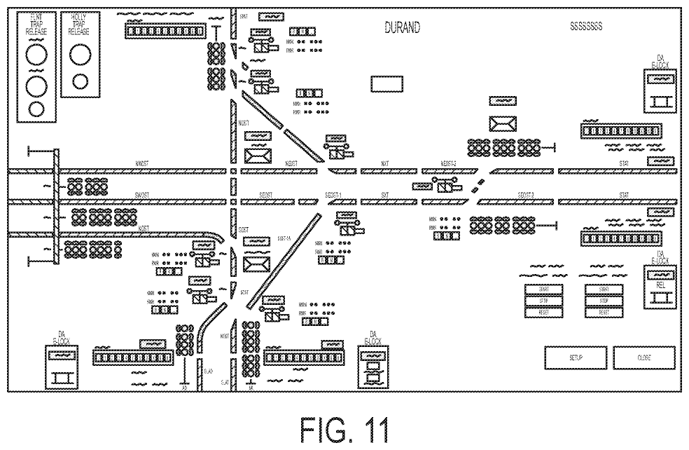

Looking to FIGS. 10 and 11, exemplary screen shot depictions of a monitor of the central computer system displaying the input and output information from a CPFE includes the status of the various input and output signals of the CPFE. As can be seen, the input and output information is displayed on a human-machine interface so that a test engineer can monitor and control the entire test configuration. In an exemplary embodiment, the data traffic of the test configuration is recorded for a portion of, or for the duration of, the test process. Thus, the entire test process can be replayed and archived for future viewing and/or verification.

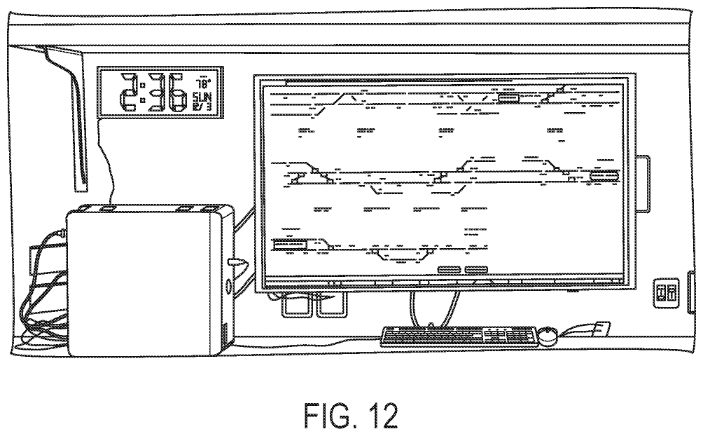

FIG. 12 is an exemplary screen shot depiction of an office control monitor of the central computer system showing a graphical depiction of the track sections under test and the status of the inputs and outputs of the track sections as communicated by the CPFEs to the central computer system.

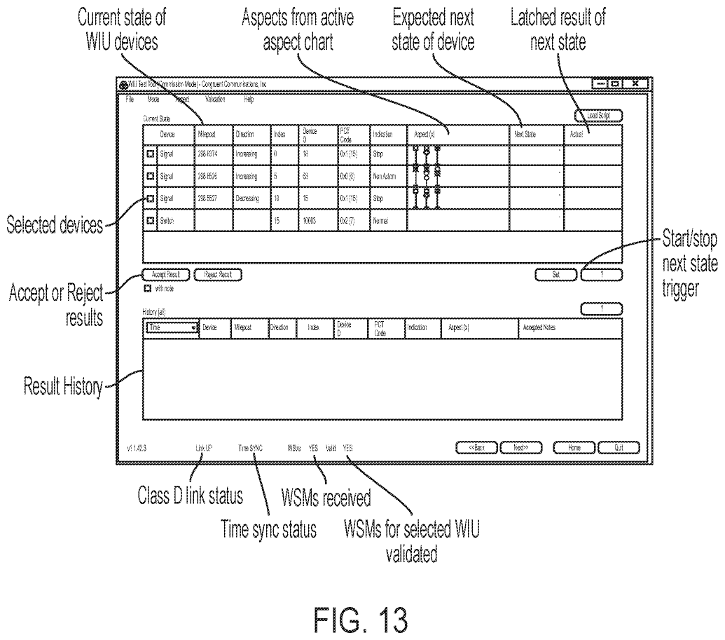

Turning to FIG. 13, in a preferred embodiment of the present invention, the CPFE box is in communication with a wayside interface unit (WIU) test tool, or WTT to allow the system to simultaneously test a positive train control (PTC) map file and configuration file installed on the WIU. Thus, using the system, a PTC test engineer can validate routes and aspect messages against actual field routes and aspects.

In an exemplary embodiment, the WIU is used in commission mode, normally used by rail operators when commissioning wayside locations. In use, the WTT communicates with and identifies WIUs based on a library of encrypted subdivision files. Preferably, those subdivision files have been imported by a user of the system of the present invention.

The imported files are most preferably the identical subdivision files use by a locomotive to navigate and implement PTC. The wayside status messages transmitted from the WIUs include device status codes that are recorded by the WTT and are later validated in order to produce a commissioning report.

With the CPFE in communication with the WTT, the system of the present invention is operable to translate system signals to PTC compatible signals and vice versa. As with other parameters of the track verification and signal testing system of the present invention, the PTC compliant signals are displayed on the monitors of the central computer system for viewing and monitoring by the test engineer operating the system.

The railroad track verification and signal testing system of the present invention allows testing and verification of the configuration and operation of one or more sections of railroad track using one or more CPFEs interfaced to the track system circuitry and communications backbone to emulate the various switch and sensor inputs and to monitor the various signal and alert outputs. Using the system of the present invention, a relatively few number of test engineers can verify a section of track in a matter of hours, as compared to conventional track verification systems and methods, which require a large number of engineers and operators physically positioned adjacent each switch, light, etc. to be verified, and taking days to complete the verification of a single track section.

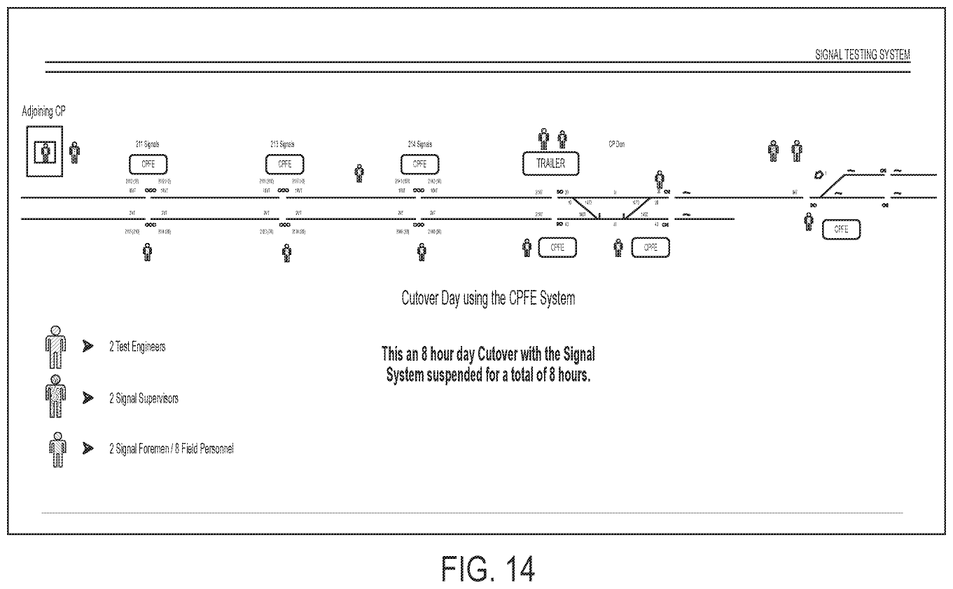

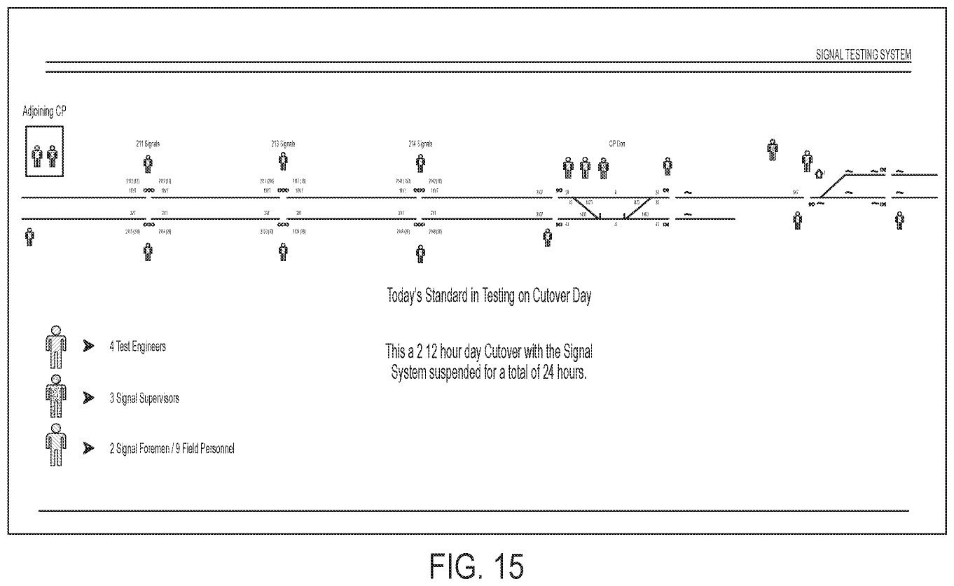

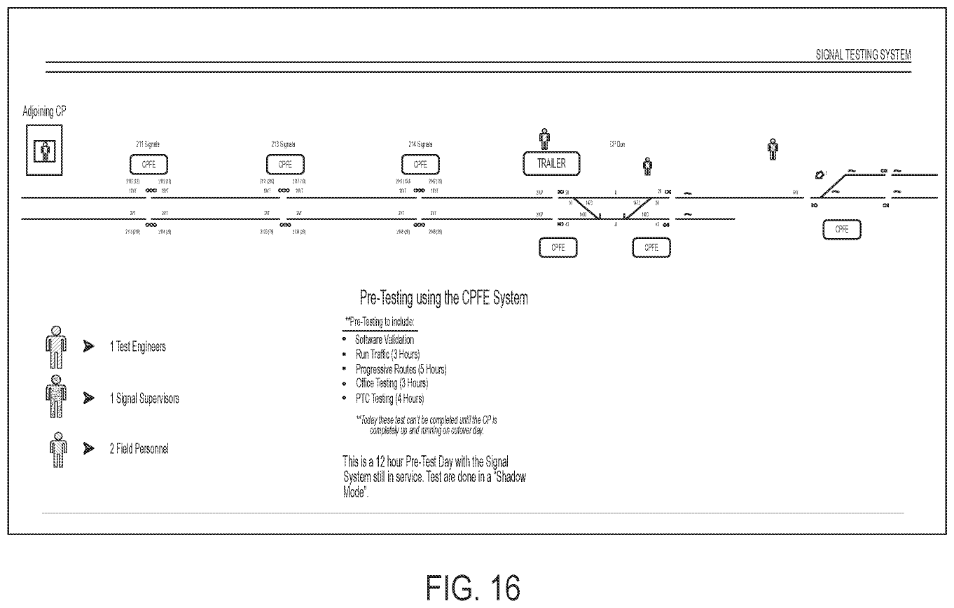

As seen in FIGS. 14 through 16, comparisons of the manhours required to complete a conventional track verification versus the manhours required to complete a verification using the system and method of the present invention are depicted.

Thus, it can be seen that the track verification and signal testing system of the present invention is well adapted to provide a time and cost efficient alternative to track verification and cutover compared to systems and methods known in the art. The configuration of a central remote location, or cutover trailer, to integrate and communicate with signal system circuitry in bungalows, and to aggregate, record, and display data and information associated with the verification and testing process provides advantages unavailable in prior art systems and methods for performing track verification. FIGS. 14, 15, and 16 depict various cost and time saving advantages of the system of the present invention over current methodology employed for track verification.

While the system of the present invention has been described with respect to various embodiments and configurations, it should be understood that many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to be inclusive of structures and arrangements or designs thereof that are within the scope of this disclosure and readily identifiable by one of skill in the art and that can perform the particular function in a similar way. Certain features and sub-combinations are of utility and may be employed without reference to other features and sub-combinations and are contemplated within the scope of the claims.

What is claimed is:

1. A track verification and signal testing system, comprising:
a central computer system; and
a control point field emulator (CPFE) in communication with the central computer system and in communication with railroad signal system circuitry of the track being, wherein the control point field emulator is operable to emulate inputs to the railroad signal system circuitry and to monitor outputs of the railroad signal system circuitry under the control of the central computer system.

2. The track verification and signal testing system of claim 1, wherein the control point field emulator is operable to emulate track system inputs comprising switch inputs, sensor inputs, data inputs, and combinations thereof; and wherein the control point field emulator is further operable to monitor track signal outputs comprising signal light outputs, alert outputs, data outputs, and combinations thereof.

3. The track verification and signal testing system of claim 1, further comprising:
a wayside interface unit in communication with the control point field emulator, wherein the wayside interface unit is operable to translate system signals to positive train control compliant signals.

4. The track verification and signal testing system of claim 1, wherein said central computer system comprises a communications interface operable to communicate over an existing railroad telecommunications fiber backbone, and wherein said CPFE comprises a communications interface operable to communicate over the existing fiber backbone, and wherein said central computer system and said CPFE communicate with each other over the existing fiber backbone.

5. The track verification and signal testing system of claim 1 comprising a plurality of CPFEs in communication with the central computer system.

6. The track verification and signal testing system of claim 5, wherein the plurality of CPFEs are located in geographically disparate locations along a section of track to be verified.

7. The track verification and signal testing system of claim 1, wherein said central computer system is operable to sequentially command the CPFE to actuate emulated inputs.

8. The track verification and signal testing system of claim 7, wherein said central computer system monitors and records railroad system outputs.

9. The track verification and signal testing system of claim 8, wherein said central computer system is further operable to display railroad system outputs in real time.

10. A track verification and signal testing system, comprising:
a central computer system;
a control point field emulator (CPFE) in communication with the central computer system and in communication with railroad signal system circuitry of the track being, wherein the control point field emulator is operable to emulate inputs to the railroad signal system circuitry and to monitor outputs of the railroad signal system circuitry under the control of the central computer system; and
a wayside interface unit in communication with the control point field emulator, wherein the wayside interface unit is operable to translate system signals to positive train control compliant signals.

11. The track verification and signal testing system of claim 10, wherein the control point field emulator is operable to emulate track system inputs comprising switch inputs, sensor inputs, data inputs, and combinations thereof; and wherein the control point field emulator is further operable to monitor track signal outputs comprising signal light outputs, alert outputs, data outputs, and combinations thereof.

12. The track verification and signal testing system of claim 10, wherein said central computer system comprises a communications interface operable to communicate over an existing railroad telecommunications fiber backbone, and wherein said CPFE comprises a communications interface operable to communicate over the existing fiber backbone, and wherein said central computer system and said CPFE communicate with each other over the existing fiber backbone.

13. The track verification and signal testing system of claim 1 comprising a plurality of CPFEs in communication with the central computer system.

14. The track verification and signal testing system of claim 13, wherein the plurality of CPFEs are located in geographically disparate locations along a section of track to be verified.

15. The track verification and signal testing system of claim 10, wherein said central computer system is operable to sequentially command the CPFE to actuate emulated inputs.

16. The track verification and signal testing system of claim 15, wherein said central computer system monitors and records railroad system outputs.

17. The track verification and signal testing system of claim 16, wherein said central computer system is further operable to display railroad system outputs in real time.
